(19) United States
(12) Patent Application Publication
(10) Pub. No.: US 2007/0160822 A1
(43) Pub. Date: Jul. 12, 2007

(54) Process for improving cycle time in making molded thermoplastic composite sheets

(76) Inventors: Paul Anthony Bristow, Goode, VA (US); Scott Michael Davis, Pittsfield, MA (US); Thomas Ebeling, Forest, VA (US); James Kenneth Forden, Aurora, CO (US); John M. S. Brown, Stockbridge, MA (US)

Correspondence Address: GEAM - 08CU - ULTEM;IP LEGAL, ONE PLASTICS AVENUE, PITTSFIELD, MA, 01201-3697, US

(21) Appl. No.: 11/314,209

(22) Filed: Dec. 21, 2005

(51) Int. Cl. B29C 51/08; B32B 3/26

(52) U.S. Cl. 428/304.4; 264/322

(57) ABSTRACT

A multilayer sheet comprises an outer decorative permeable film layer, an adherent layer of insulating fiberglass, and an open cellular fibrous layer intermediate the outer decorative film layer and the insulating fiberglass. The open cellular fibrous layer comprises fibers bonded together with a thermoplastic resin. The outer decorative layer is adhered to the open cellular fibrous layer through a permeable adhesive web.

### FIELD OF THE INVENTION

The present invention relates to a method of improving or reducing the cycle time that it takes to make an intermediate or final shaped molded thermoplastic composite sheet for use as, for example, an automobile body part.

### BACKGROUND OF THE INVENTION

Market economics for aesthetic composite structures comprising a substrate and an aesthetic surface layer often favor use of thermosetting resin systems for the substrate. Low raw material and tooling costs are frequently cited as factors supporting selection of thermosetting materials. However, use of thermosetting materials can produce volatile organic compound (VOC) emissions, and generally require long cycle times.

For example, one commonly used approach for creating decorative parts involves a two step procedure, wherein a thermoplastic surface layer is formed using a traditional thermoforming method and then a thermosetting material is injected or sprayed behind this surface layer and is cured in-place to create a bi-layered structure having a reinforced sub-layer and a thermoplastic surface layer. Many thermosetting systems and methods are employed to create the reinforced sub-layer. These include, for example, spray-up fiberglass reinforced plastic (FRP), resin transfer molding, vacuum-infusion, and various reinforced foam in-place technologies.

While these processes have been received well in the automotive industry, the comparatively low sales of thermoplastic sheet product and the continued use of stamped metal body parts indicate the inability or unwillingness of the automotive industry to move towards thermoplastic body panels. The underlying reasons are believed to have to do with an inability to produce class “A” body parts, and when class “A” body panels can be produced, the long cycle times required to produce thermoset based body panels having the smooth high quality exterior suitable for finishing to produce a class “A” surface.

Class “A” refers to a system of labeling automotive body parts based upon the visibility of the part to end-users. For example, Class “A” refers to a body part that is visible, like the hood of the car. Class B is visible but not essential: like the door aperture. Class C is not visible, like the seat mounting under the carpet. Since class “A” body parts are visible, they must meet the highest standards of exterior surfaces in the automotive arena. Class “A” surfaces have no or minimal visible surface defects, depending on the type of defect. Currently most Class “A” surfaces are typically painted sheet metal. However, some body parts, like car hoods and bumpers, are increasing manufactured from polymer resins.

Currently, the most popular plastic materials used for automotive parts and bumpers are SMC for horizontal body panels and injection materials for vertical body panels. Thermoset body panel materials—“class A”—are dominated by single system SMC (sheet molding compound—a low viscosity polyester system) structures. These are matched tool molded at relatively modest pressures (relative to injection molding—say 1000 psi) and are cured in the tool. “SMC” is a generic term that covers a broad range of product formulations. Generally, these highly filled thermoset systems are based on unsaturated polyester chemistries. So-called low profile additives, lubricants, mold releases and all manner of other additives are used to improve surface finish, mold release and other important parameters.

Glass mat thermoplastic (GMT) composites are a family of compression-moldable, fiberglass-reinforced materials with thermoplastic matrices whose mechanical properties are generally higher than those of standard, injection-molded thermoplastic composites. GMT is available in the following glass-mat types: continuous-strand, randomly oriented glass-mat products which provide a good balance of stiffness and strength in all three axes; unidirectional long-glass-fiber mats which add directional stiffness and strength in a single axis; and, long, chopped fiber glass mats which provide improved flow properties and improvements in energy management with minimum decrease in stiffness.

The different glass mats are combined with a thermoplastic resin, usually polypropylene, (although other higher temperature engineering resins are also offered) to form a moldable product. GMT products are supplied in sheet or blank form to processors who shape the materials by compression molding or thermostamping.

The use of polymer parts in autobodys has been predicted for decades, but have not yet become dominant despite their advantageous light weight and lower cost. The long production times to make polymer based body panels is one of the reasons why polymer composite sheet materials have not caught on. With the sharp spike in oil prices and the move towards more energy efficient automobiles, resolution of the problems impeding the use of polymer based body panels in more widespread automotive body panels becomes more urgent.

These processes have been received well in the automotive industry, but comparatively low sales of thermoplastic sheet product and the continued use of stamped metal body parts indicate the inability or unwillingness of the automotive industry to move towards thermoplastic body panels. The underlying reasons are believed to have to do with the inability of producing class “A” body parts, and the long cycle times required to produce thermoset based body panels having smooth high quality exterior suitable for finishing to produce a class “A” surface.

For these reasons sheet molded compound (SMC) parts are being increasingly investigated for use as replacements for conventional steel exterior automotive body panels such as rear deck lids, hoods, roof panels and, to some extent, doors, as opposed to thermoplastic sheet. These exterior body panels are characterized by a generally flat large major surface.

Currently, the use of thermoplastic composite sheet material can be molded for use in automotive body parts, albeit at a high cost and long cycle times. Typically the current processes in industrial use require a 3-4 hour long mold cycle time to impart the final shape to a thermoplastic composite sheet material for use as a Class “A” body part. A well designed tool and lay-up could be cycled in 1-2 hours including lay-up, bagging, cycling and demolding. The extended times required to heat and then cool the mold between cycles using traditional heating methods has significantly contributed to these long cycle times because most mold heating/cooling technologies are designed to maintain the mold at a constant temperature. Changing the mold temperature requires a significant amount of energy, due in large part to the mass of the mold.

In U.S. Pat. Nos. 3,626,053 and 3,621,092, processes are described for molding fiberglass reinforced thermoplastic sheets utilizing presses. In the processes described in both patents, a reinforcing mat, typically formed of glass fibers, is utilized to reinforce thermoplastic resin in sheet form. The mat reinforced sheets are then stamped into shaped intermediate or final parts utilizing a press. Prior to placing the sheets in the press for stamping into shaped parts, however, the sheets are heated to a temperature sufficient to render the resin of the sheet molten or flowable while maintaining the temperature of the sheet below the decomposition temperatures of the thermoplastic resin used to prepare the sheet. The heating systems described in both of these patents involve infrared ovens.

Various other patents have issued which relate to fiber reinforced thermoplastic sheet products such as those described in the aforementioned patents. Exemplary of some of these other patents are U.S. Pat. Nos. 3,664,909, 3,684,645 and 4,335,176. In all of these patents the product described is suitable for use in stamping or compression molding operations. As described in the aforementioned patents, rendering the resin molten prior to molding the fiber reinforced sheet, permits the resin to flow during molding and the reinforcement flows with the resin. This provides a shaped part which has reinforcement uniformly distributed throughout.

In a typical flow forming process the thermoplastic composite sheet blank is heated in a conventional oven by convection or infrared radiation to a temperature in the range of about 200° C. to about 375° C., depending on the thermoplastic resin. During the initial heating in the oven the fibers expand, resulting in a resin poor coating of the composite surface. In addition, this expansion of the fibers results in a lofting, or movement, of the fibers into the resin surface layers.

Following the oven heating, a composite such as SMC or GMT is transferred to the mold where it is shaped by applying pressure in the range of about 1000 lb/in² to about 5000 lb/in² with mold surfaces whose temperatures range from about 55° C. to 200° C. During the transfer of the composite from the oven to the mold the composite surface cools and the surface resins “freeze” into position with a glass rich rough surface. This “freezing” of the resin at the surface prevents the resin from flowing readily during the molding process and, consequently, rough boundaries are produced between the newly formed surface areas and the original surface areas. In addition, the resulting composite surface is only partially filled with resins, even though some hot resin will move from the composite core to the surface during the molding process. This partially filled resin surface, particularly around and near the lofted fibers, is a major cause of surface roughness.

This problem of surface roughness is particularly troublesome for composites of crystalline thermoplastic resins because crystalline thermoplastic resins exhibit substantial shrinkage during cooling thereby projecting fibers at the surface of the composite.

For these reasons it has been difficult to provide these panels with smooth, pit free high quality finishes (referred to as Class A finishes in the industry) that are pit free using conventional GMT compression molding techniques. Flaws or other surface deviations in the part after molding often require the use of filling and hand finishing operations to achieve the desired surface quality.

In recent years a process called “In-Mold Coating” has been developed for the purpose of improving the surface quality of SMC parts. Basically, the in-mold coating process employs an additional operation whereby a coating material is injected onto the part while the molds are partially open. The molds are then re-closed and the coating material flows over the part surface filling pits, pores and cracks providing a nearly blemish-free coated surface.

Unfortunately, several problems have been encountered with this process. For example, the conventional use of ejector pins pressing against the underside of the major flat surface of the part to eject it from the mold often causes deformations that “telescope” or show through the upper coated surface thereby destroying its high quality finish. Another problem is that the part has a tendency to lift off of the lower male mold when the molds are opened to allow injection of the coating material. The resulting shifting or lifting of the part creates suction that may lodge debris underneath the part and cause further distortion when the molds are reclosed. If the part lifts a sufficient distance from the lower mold the coating material may actually be injected underneath the part instead of on its upper surface. In some instances this problem can also result in breaking or cracking the part when the molds are reclosed during curing of the coating material.

Induction heating, whereby a metal is heated using electromagnetic energy has been known for at least 75 years and is currently used extensively to process metals. More recently induction heating has been used to heat mold cavities for various rubbers to make, for example, tires, molded thermoplastics, and composite materials. See for example: EPO publication number 0 183 450, to Sumner et al., published Jun. 4, 1986; UK Patent Application GB 2 065 022 A, to William Langridge, published on Jun. 21, 1981; and, US 2004/0058027 to Guichard et al., published Mar. 25, 2004.

There is a continuing need in the art for lightweight transportation (plane, train, auto, etc.) body panels having a smooth exterior surface, suitable for finishing as a class “A” surface with the application of paint and coatings without the necessity of correcting flaws or other surface deviations through the use of filling and hand finishing operations to achieve the desired surface quality finish, having brief and/or economically feasible cycle times.

### SUMMARY OF THE INVENTION

The present invention is directed to a process for reducing the cycle time that it takes to prepare a final or intermediate product from a thermoplastic composite sheet comprising: i) heating the thermoplastic composite sheet to a temperature above the melting temperature of the thermoplastic resin making up the sheet; ii) applying a shape to the sheet material with a cycle time of under 45 minutes.

The present invention is also directed to a process for reducing the cycle time that it takes to prepare a final or intermediate molded product from a thermoplastic composite sheet comprising: a) conveying a heated thermoplastic composite sheet material to a mold; wherein the temperature of the heated thermoplastic composite material is above the melt temperature of the sheet material; b) placing the heated thermoplastic composite sheet material into a mold; c) heating the surface of the mold cavity which comes into contact with the thermoplastic composite sheet to a temperature, and for a period of time, sufficient to shape the thermoplastic composite sheet to its final shape; d) actuating the mold so that the thermoplastic sheet material takes on the shape of the mold cavity; e) cooling the surface of the mold cavity which comes into contact with the thermoplastic composite sheet for a period of time sufficient to allow the thermoplastic composite sheet to release from the mold; f) ejecting the thermoplastic composite sheet material in its final shape from the mold.

The above-described and other features will be appreciated and understood by those skilled in the art from the following detailed description, drawings, and appended claims.

### BRIEF DESCRIPTION OF THE DRAWINGS

Refer now to the figures, which are exemplary embodiments, and wherein the like elements are numbered alike.

FIG. 1 is a cross-sectional schematic side view of an induction mold heating process schematic. Composite thermoplastic sheet (2) moves through a sheet pre-heating oven (1) in the direction of the mold press (9 and 10) and the mold (7 and 8). The composite thermoplastic sheet (2) is then conveyed from the pre-heating oven (2) to the mold (7 and 8) using a conveyor belt or frame style system (4). After being placed in the mold, the composite thermoplastic sheet (2) is shaped using upper mold face surface (7) and lower mold face surface (8), through the application of induced heat provided by electrical energy-generated by an RF power generator (11) and transferred to the coils (6) using electrical cables (12). The upper and lower mold face surfaces are cooled using water brought to and from the mold (7 and 8) via conduit (5). (9) and (10) make up the press onto which the mold (7 and 8) and heads are attached. From the mold (7 and 8) the composite thermoplastic sheet (2) can be ejected from the mold and moved to another area where the finished part is trimmed and painted.

FIGS. 2-5 show a composite thermoplastic sheet (2) moving through the oven (1) in the direction of the mold (7 and 8) is a cross-sectional schematic side view of an induction mold heating process schematic.

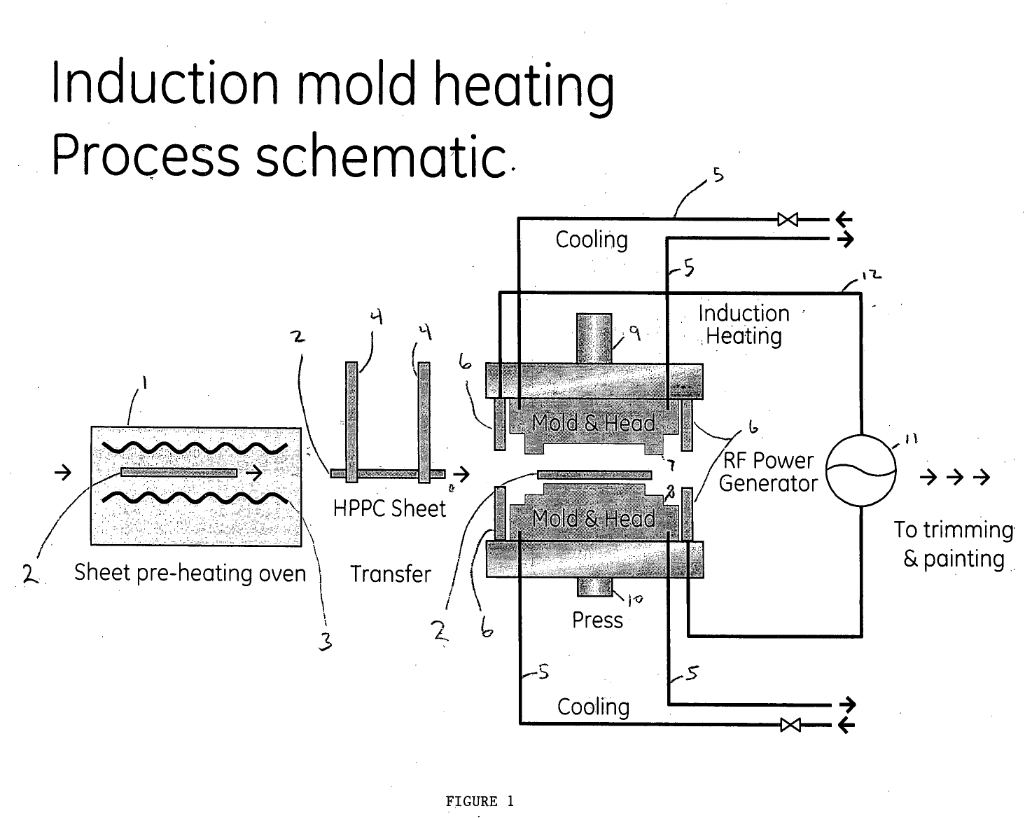

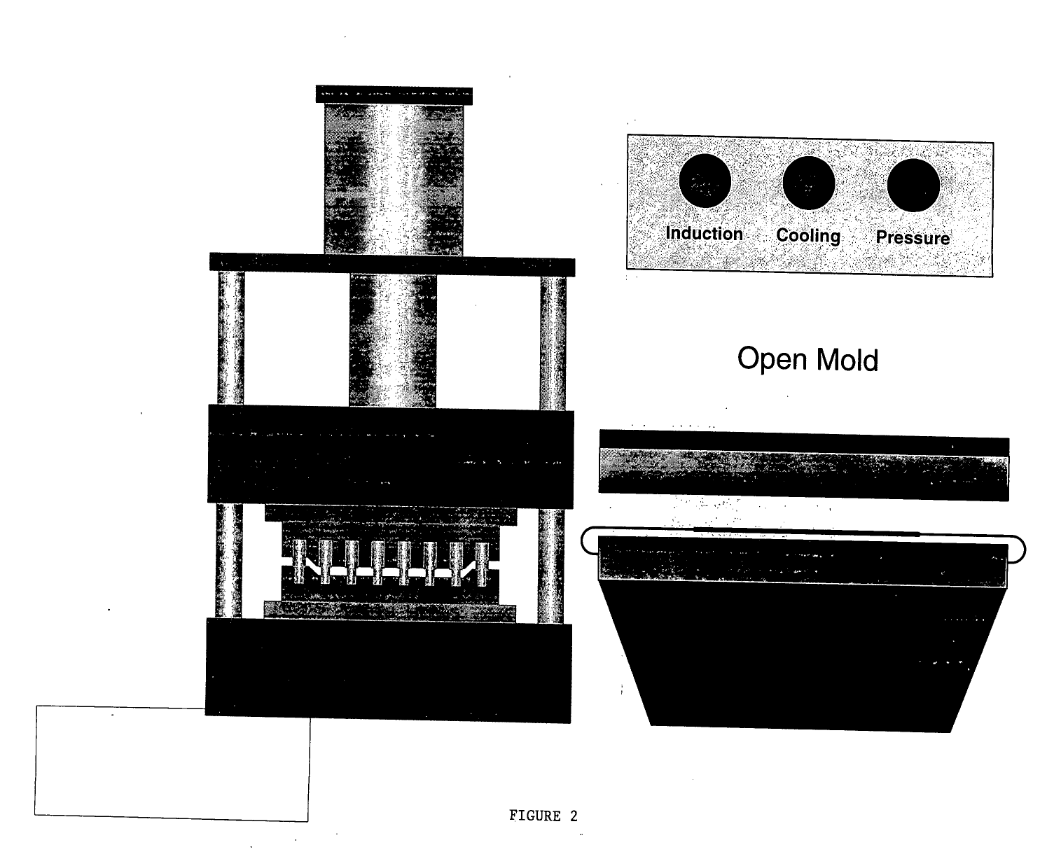

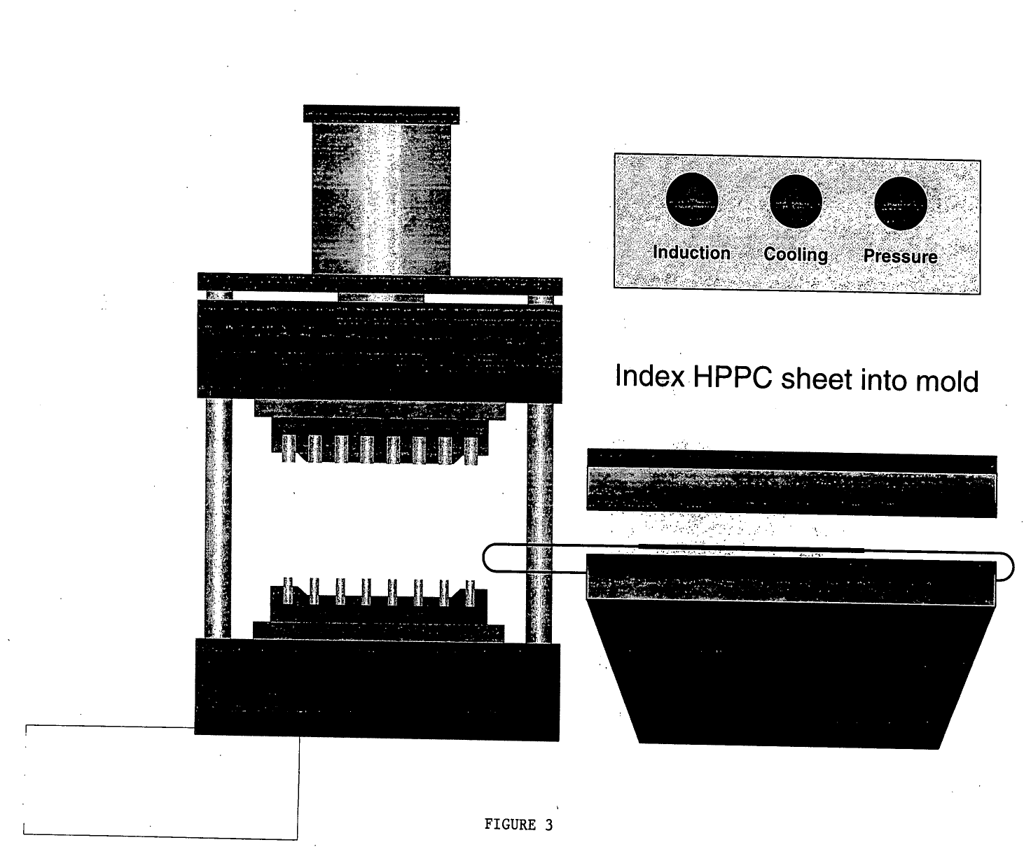

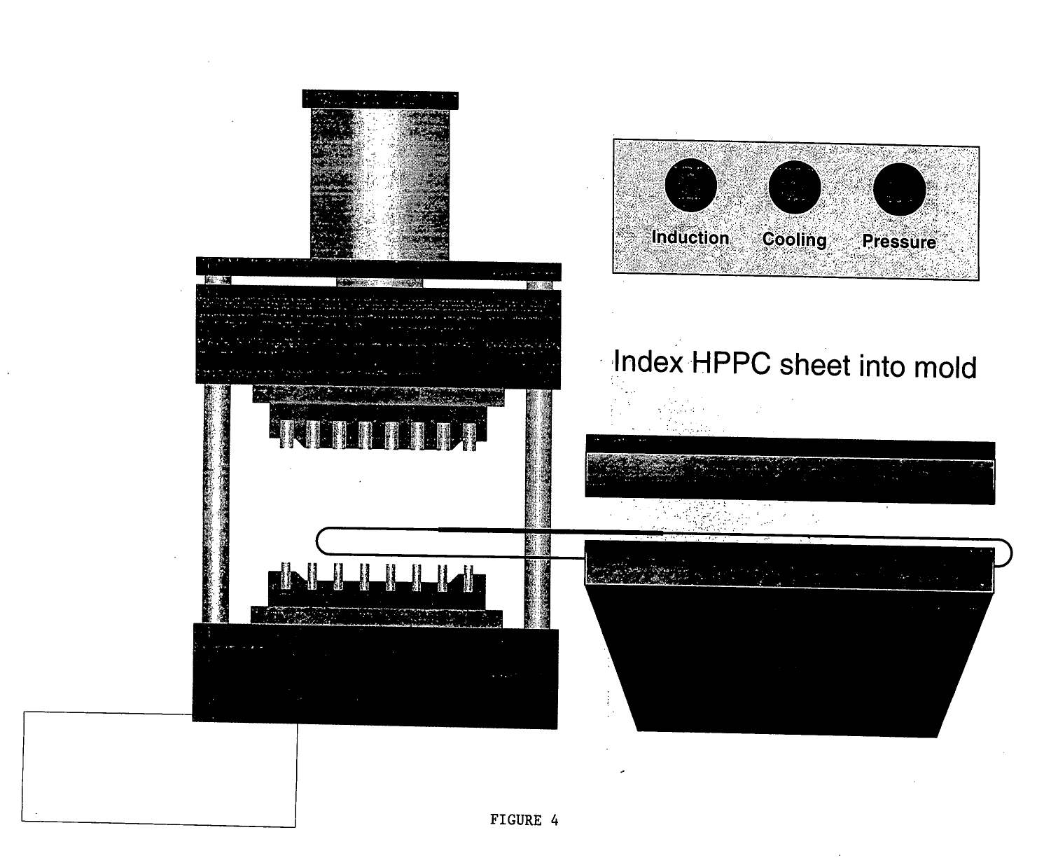

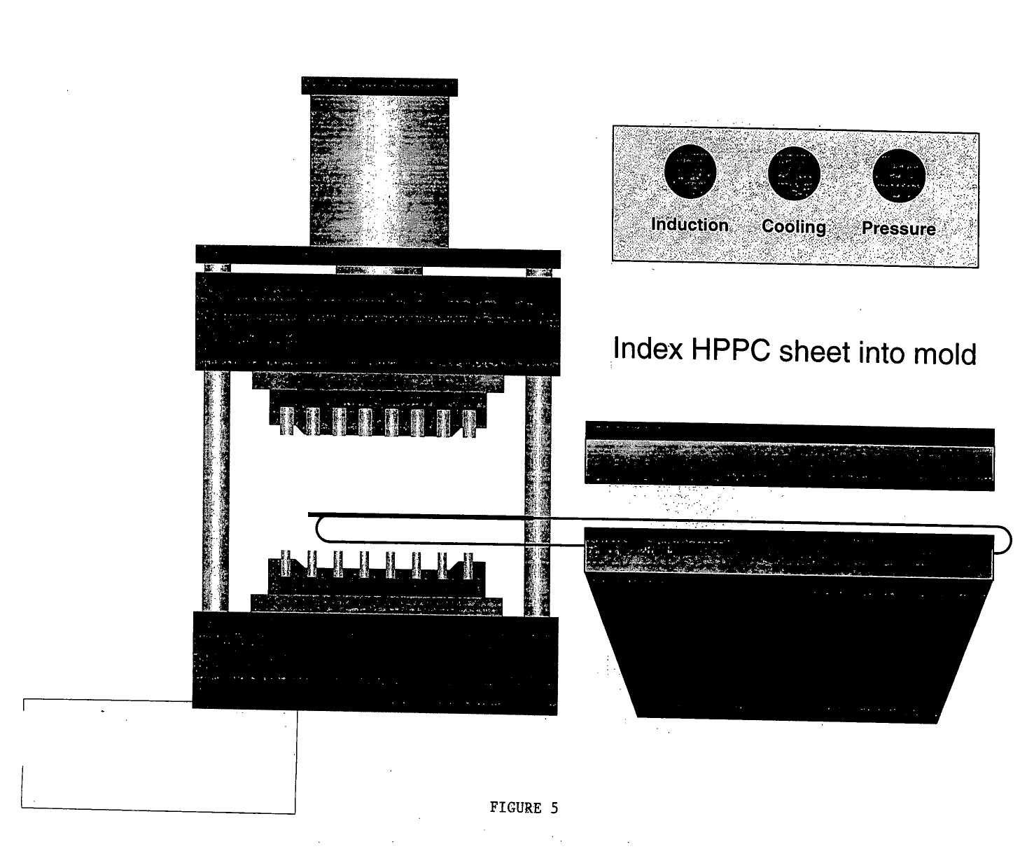

### DETAILED DESCRIPTION OF THE INVENTION

For purposes of the present invention the term “cycle” relates to the number of intermediate or final molded articles that can be made in a one hour period. The equation by which cycle time is determined is 60 minutes divided by the number of molded articles formed in a one hour period. For example, if according to a process, 10 molded articles can be formed in a one hour period then the cycle time would be 6 minutes. This defines cycle time for actual production lines that are producing molded articles, as opposed to individual articles which may be produced quickly under experimental or test conditions.

The term “thermoforming” and its various derivatives have their ordinary meaning, and are used herein to generically describe a method of heating and forming a sheet into a desired shape. Thermoforming methods and tools are described in detail in DuBois and Pribble's “Plastics Mold Engineering Handbook”, Fifth Edition, 1995, pages 468 to 498.

In accordance with the present invention a mold comprises at least one mold member defining at least part of a mold cavity having a shape to be imparted to the molded material.

A mold face surface is the surface of the mold that will come into contact with and shape the thermoplastic composite sheet material.

For purposes herein a susceptor is a metallic based article that will come into contact with the material to be molded and is capable of attaining a temperature sufficient to heat the sheet material to be molded above the melting point of one or more of the materials comprising the sheet material. The susceptor may be for example, the mold face surface itself or a mold insert such as that described in U.S. Pat. No. 5,260,017 to Giles Jr., on Nov. 9, 1993.

The present invention is directed to methods for molding thermoplastic composite sheet materials into a desired shape with a cycle time of less than forty five (45) minutes. A process for improving the cycle time that it takes to prepare a final or intermediate product from a thermoplastic composite sheet comprising: i) heating the sheet to a temperature above the melting temperature of the thermoplastic resin making up the sheet; ii) applying a shape to the sheet material with a cycle time of under forty five (45) minutes or in another embodiment under thirty (30) minutes.

In particular, the process of the present invention is directed to a process for reducing the cycle time that it takes to prepare a final or intermediate molded product from a thermoplastic composite sheet comprising: a) conveying a thermoplastic composite sheet material to a mold; b) placing the thermoplastic composite sheet material into a mold; c) actuating the mold so that the thermoplastic sheet material takes on the shape of the mold cavity; d) ejecting the thermoplastic composite sheet material in its final shape from the mold and repeating this cycle in a total time period of 45 minutes or less.

The plastic materials of the sheet comprise sufficient bonding capability to provide sufficient structural integrity to the sheet to enable thermoforming thereof.

Conveying

Heated or unheated sheet material is conveyed to the next process step using any suitable conveying means. The skilled artisan will appreciate the maturity of the conveyor art and will know which conveyor systems can be used to convey sheet material depending upon the weight and the size of the sheet for example. In one embodiment a pin chain conveyor system is used to transport the unheated and then heated sheet to first the pre-heating oven and then the mold. In another embodiment a clamp conveyer will be employed to move the composite thermoplastic sheet to each different step of the process. The conveyor system may be long and integrated such that only one conveyor belt is necessary to accept the sheet material, pre-heat the sheet material, in the event that the sheet is going to be pre-heated, convey the composite thermoplastic sheet material to the mold, and then place the composite thermoplastic sheet material between the mold face surfaces.

In accordance with the invention, a method is provided for preparing sheets of fiber reinforced thermoplastic resins in which a conveyor system moves the sheets through an oven on a continuous basis on a conveyor system which constantly circulates through the oven. In another aspect of the invention, an oven is provided for heating these fiber reinforced composite thermoplastic In another aspect of the invention, means are provided within the ovens contemplated to constantly clean the gas circulating therein to remove all foreign debris present in the atmosphere.

Direct or indirect heat may be employed to preheat the thermoplastic composite sheet in order to speed the molding process. Other contemplated embodiments include heating methods such as infra-red, electrical resistance, flame, or microwave heat. If a pre-heating step is employed, it can be employed in association with the conveyor system such that the conveyor system carries the sheet material through, for example, a gas fired or electrical resistance oven such that the sheet material is not significantly delayed in being conveyed to the mold.

The pre-heating step can heat the sheet material to any desired temperature so long as the temperature does not exceed the temperature at which the resin making up the thermoplastic matrix will decompose. In one embodiment, the pre-heating oven will heat the sheet material to at least the melting point temperature of the thermoplastic resin making up the matrix of the sheet material.

Hot gases, preferably air, although any gas inert to the resin sheets treated may be used, are passed around the sheets contained on the conveyor on all surfaces thereof at temperatures in excess of the melting temperature of the resin utilized in the sheet. The circulation rate of the hot gas is maintained at a rate acceptable for either heating the sheet or heating the mold, using for example an impingement pre-heating step and the conveyor system will maintain the sheet within an oven for a residence time sufficient to permit the resin to become molten or flowable throughout the sheet.

The sheet material may stay in the oven for any period of time sufficient to bring the temperature of the thermoplastic(s) making up the sheet to attain its melt temperature or higher without degrading the thermoplastic. In one embodiment of the present invention, the composite thermoplastic sheet is heated to a surface temperature of 500° F. in a period of time less than or equal to 8 minutes, or, in another embodiment, to a surface temperature of 500° F. in a period of time less than 5 minutes. The skilled artisan will appreciate that the less time it takes to pre-heat the composite thermoplastic sheet, regardless of its composition, the more favorable the economics of the process. In another embodiment of the present invention the time to pre-heat the composite thermoplastic sheet to a surface temperature of between 150° F. and 500° F. may also be less than 3 minutes. The time frames given relate only to the pre-heating and conveying steps, if performed, so that it is understood that by using a continuous process the composite thermoplastic sheets will be able to be fed to the mold so as to achieve the lowest feasible cycle time. Thus, for example, by placing ten sheets continuously on a conveyor, despite the residence time of each individual sheet in the oven, the sheets can be fed to the mold in a time frame such that the cycle times according to the present invention can be met.

The present invention is directed to producing a thermoplastic surface suitable for a class “A” finish upon painting without the necessity of filling any defects or performing any manual finishing operations. In this sense, and for purposes off the present invention, a class “A” surface is that on a exterior body panel of an automobile or truck, including the hood, quarter panels, door panels roof and trunk at least. A class “A” surface is one of the highest quality surfaces produced in the automotive industry. The rigorous requirements established by the large automobile companies maintain that a class “A” surface shall have at least four or more of the following characteristics: a) the surface is free of voids which expose bare substrate upon a visual evaluation and comparison to boundary of sheet; b) the surface is free of detectable bubbles in the surface upon visual evaluation and comparison to boundary of sheet; c) the surface is free of detectable surface depressions upon visual evaluation and comparison to boundary of sheet; c) the surface is free of detectable and irregular spots of removed coating from underlying coating or substrate upon visual evaluation and comparison to boundary of sheet; d) the surface is free of detectable rust, corrosion and oxidation upon visual evaluation and comparison to boundary of sheet; e) the surface is free of cracks, splits or punctures in the substrate upon visual evaluation and comparison to boundary of sheet; f) the surface is free of cracking, crazing or hairline breaks in the applied surface upon visual evaluation and comparison to boundary of sheet; g) the surface is free of round depressions upon visual evaluation and comparison to boundary of sheet; h) the surface is free of depressions or protrusions in substrate upon visual evaluation and comparison to boundary of sheet; i) the surface is substantially free of foreign object or contaminant in coating film upon visual evaluation and comparison to boundary of sheet with up to 4 defects per panel where each defect is ≦1 mm Ø and is separate from any other defect by 100 mm; j) the surface is free of coating material from a different target area upon visual evaluation and comparison to boundary of sheet; k) the surface is free of drops of coating deposited on the finished surface upon visual evaluation and comparison to boundary of sheet; l) the surface is free of peeling or loss of adhesion between coating films or between coating and substrate upon visual evaluation and comparison to boundary of sheet; m) the surface is free of holes in the coating film upon visual evaluation and comparison to boundary samples; and, at least two properties selected from the group consisting of: i) the surface has a distinctness of image reflected by coating according to a DOI meter of at least, or less than 85 as tested on a BYK-Gardner-Model GB 4816 at 9104 Guilford Road/Columbia, Md. 21046/Phone 800-343-7721, with the DOI being consistent over the entire sheet with maximum variation on any individual sheet being a maximum of 15 units variation; ii) the surface has a gloss by a Class meter (see 3.1.3.5). BC/CC of at least 20, or 30, or 40 or 50 or 60, or 70 or 80 according to a BYK-Gardner glass meter, Hunter Dor-I-Gon, ATI, with the gloss being consistent over the entire part with the maximum variation on any individual part for gloss being a maximum of 15 units variation; and, iii) the surface has an acceptable orange peel test value according to a BYK-Gardner wave scan measurement (GB 4816 series): available from BYK-Gardner at 9104 Guilford Road, Columbia, Md. 21046/Phone 800-343-7721 with an orange peel that is consistent over the entire part with a maximum variation on any individual part for orange peel being a maximum of one unit variation within a 120 mm span.

In order to achieve a class “A” surface the base material upon which a coating, ie, paint, clear coat, etc. is to be applied, must be free, or substantially free of, defects and imperfections. According to the process of the present invention, the mold face surfaces are smooth as well as substantially defect and imperfection free. Using such molds it is possible to obtain thermoplastic surfaces from the mold capable of becoming class “A” surfaces with the application of paint and finish only (ie, there are no pits or defects requiring filling or other manual surface finishing work). According to one embodiment of the present invention the mold face surfaces will have a smooth class “A” finish in the shape of the intermediate or final part being made upon the application of paint to the part.

The skilled artisan will appreciate that “actuating the mold” can mean the application of any conditions for shaping a thermoplastic composite sheet in a mold. Typically the actuation of the mold will include the heating of the surface of the mold cavity which comes into contact with the thermoplastic composite sheet to a temperature, and for a period of time, sufficient to shape the thermoplastic composite sheet to its final shape, with or without the application of a pressure (vacuum) above (below) 0 barr. In one embodiment this means moving the mold faces together so they come into contact with the composite thermoplastic sheet material and the sheet material will take on the shape of the mold face surfaces.

Actuating the mold may require the application of heat to the mold faces. The amount of heat required is dependant on the polymers making up the sheet material, however, the mold will generally have the capability of heating a thermoplastic material above the melting point of the thermoplastic resin making up the matrix of sheet material. The melt temperatures of most if not all known thermoplastic polymers is available in the public domain. The mold face surfaces may be heated to any temperature from about 25 to about 500 inclusive of all integer number temperatures. In different embodiments the temperature may be more than 25, 50, 75, 100, 150, 180, 200, 217, 250, 275, 300, 350, 400 and 500 degrees Celsius. Higher temperatures above 180 degrees Celsius are included to take into account the relatively new high temperature polymers that are being produced such as PEI, PEEK, etc. The skilled artisan will also appreciate that the mold may be heated either before, during or both before and during, that time when the sheet material has been placed in the mold during any particular cycle.

In one embodiment of the present invention, it is the mold face surface that is heated. By heating the mold face surface as opposed to the entire mass of the mold, energy consumption, heating and cooling times, and cycle time are reduced. For purposes of the present invention the mold face surface may be that portion of a mold to a 10 cm depth from the mold surface that is to come into contact with the material to be molded. In another embodiment, the mold surface is that 3 cm, 2 cm, 1 cm, 5.0 mm, 2.5 mm, 1 mm, 0.5 mm, 0.25 mm and 0.10 mm depth from the mold face surface that is to come into contact with the material to be molded. The skilled artisan will appreciate that better processing parameters will be achieved with the smallest portion (depth) of the mold face surface to be heated to a temperature above the melt temperature of the thermoplastic comprising the sheet.

Heating just the surface of the mold that comes into contact with the thermoplastic composite while maintaining the rest of the mold at a lower temperature requires less time and energy. Current rapid heating techniques include an open flame, IR, induction, microwaves, and electrical heating elements manufactured into the surface of the mold. In addition to these active processes there are passive processes like coating the mold with a ceramic or polymer insulator for flash/instantaneous heat. There could be combinations of passive and active solutions.

The mold can be heated with any type of heating technology which will reduce the cycle time for manufacturing sheet material. The heat may be applied using conduction or induction, direct or indirect heat. These methods of heating a mold are known. In one embodiment only the face surfaces of the mold are heated using electromagnetically generated induction heat.

Inductive heat generated by an electromagnet field is advantageous because the mold faces or molding surfaces can be heated, rather than the entire mold. This heat is eco-friendly by reducing the amount of resources, ie electricity, necessary to heat the mold to an acceptable temperature depending on the type of sheet material. Moreover, the use of inductive heat is advantageous because it is possible to heat the mold surfaces in short periods of time and under some conditions almost instantaneously, again aiding in the reduction of cycle time.

Depending on the susceptors used and the application, based on the teachings herein, one of ordinary skill in the art can readily determine the frequency and strength of the magnetic field used to induce heating in the present methods and apparatuses. In a broad sense the useful frequency range is from about 1 KHz to about 40 MHz, or in another embodiment from 10-1000 kHz, or in yet another embodiment from 10-100 kHz. The skilled artisan will know that there is a relationship between the frequency of the alternating current and the depth to which it penetrates in the work piece. So for example, low frequencies, between 5-30 kHz, are effective for thicker materials requiring deep heat penetration and that higher frequencies of 100 kHz to 400 kHz are effective for smaller parts or shallow penetration. Moreover, the skilled artisan will know that the higher the frequency, the higher the heating rate. The induced current flow within the part is most intense on the surface, and decays rapidly below the surface. Outside will heat more quickly than the inside and that 80% of the heat produced in the susceptor is produced in the outer skin. This is described as skin depth and can be described as:
Depth of Penetration=the square root of (2/ωσμ)
where ω is Frequency, σ is Conductivity and, μ is frequency.

The power ranges of the inductor can be from about 1 KW to about 5 MW or in an alternate embodiment from 1 KW to about 1500 KW. One of ordinary skill in the art can select the appropriate power based upon the power output, frequency and the heating requirements.

Depending on the susceptors used, the field generated by the induction coil influences the heating patterns of the susceptors and the field is a function of the coil geometry. Examples of coil design include solenoid, pancake, conical and Helmholtz. While these coil types are among those commonly used by industry, certain embodiments of invention may require specialized coils. For example, in certain embodiments solenoid coils are preferred because solenoid coil geometry produces a very strong magnetic field. In other embodiments, pancake coils are used. Pancake coils have been found to produce a non-uniform field with its maximum at the center. One of ordinary skill in the art can readily select the type of coil based on the teachings in the art and set forth herein.

Magnetic field strength are effected by number of coil turns, the shape of the coil and the diameter of the coil. The factors can be readily manipulated by one of ordinary skill in the art to select combinations of these factors to obtain the desired magnetic field strength.

Solenoid Coil geometry produces the strongest field of all the possible geometries. Pancake coils are most common in one-sided heating applications and may be used in one embodiment of the present invention on the two halves, thirds or other pieces of the mold. In another embodiment, the coil can be a “cage” which completely surrounds the mold. Such a “cage” mold is described in U.S. Ser. No. 10/415,651 to Guichard et al. and W/O 2005/094127 and its US equivalent application, herein incorporated by reference in their entirety. As known to the skilled artisan changing the coil parameters, e.g., spacing between turns or the number of turns can change the field values, but the pattern is generally the same. Magnetic field strength increases if the coil-part separation is reduced. If the part is placed very close to the coil, one may see the heating dictated by each turn of the coil.

Using induction technology it is possible to heat the mold in less than 20 minutes, although in other embodiments the mold can be heated in less than 15, 10, 9, 8, 7, 6, 5, 4, 3, 2, and 1 minutes. Any other heating technology which will accomplish these same time frames may be suitable for use in the present invention.

Depending upon the underlying thermoplastic resin, among other considerations, these different processes may provide different balancing of several different factors including cycle time, unit production volume, part design (ie flat/2d shape/3d shape/complex), energy consumption, tool/process cost and safety. The skilled artisan will appreciate that each process will have clear weakness like hot spots or non-uniform heating, special metal alloys or ceramics, limited tool life, etc. . . . and there will be some amount of change in these variables between processes to produce different sheet products.

The sheet to be molded and/or the mold can be heated using any means which will produce a cycle time under 45 minutes. Methods of heating can be direct or indirect.

Actuating the mold may also require the application of pressure (and/or vacuum) to the sheet material. The amount of pressure, like the amount of heat, is largely dependant upon the thermoplastic material making up the sheet. According to one embodiment, the pressure will be in the range of 1-4 Barr, although higher pressures of up to 10 or 15 Barr and lower pressures down to 0 Barr may be appropriate for some applications and materials. The mold pressure on the article to be molded can be any pressure suitable to mold a particular sheet material, however it is preferred to have a mold pressure of between 0 and 100 lbs/in² so that the more expensive machinery and increased costs necessary to use mold pressures above 100 lbs/in² can be avoided.

Ah incidental, but extremely important benefit of heating the mold surfaces is improved inter-laminar and intra-laminar adhesion in multi-layer thermoplastic systems over what could be produced using the same sheet and process without heating the mold to the melting point of the thermoplastic resin or above. This increase in inter-laminar and infra-laminar is significant and is measurable in the short beam shear according to ISO 14130, in plane compressive properties according to ISO 14126, flex according to ISO 14125 and peel test using an appropriate test.

Cycle time can vary depending on the thermoplastic material making up the sheet, the temperature to which the molds must be heated, how fast the mold can be cooled as well as other considerations known to the skilled artisan. For purposes of the present invention the cycle time may be any time period below about forty five (45) minutes. This range specifically includes all integer numbers between 0 and 45, specifically including but not limited to, 1, 2, 3, 4, 5, 6, 7, 8, 9, 10, 11, 12, 13, 14, 15, 20, 25, 30 35, 40 and 45 minute periods. The skilled artisan will appreciate that depending on the manufacturing consideration, different cycle times may be warranted for different products depending on cost, material, etc.

The artisan skilled in the molding art will also appreciate that the cooling of the surface of the mold cavity which comes into contact with the thermoplastic composite sheet for a period of time sufficient to allow the thermoplastic composite sheet to release from the mold. For part ejection and fast cycle times, the mold may be cooled to a temperature below the Tg of the thermoplastic(s) making up the exterior and/or interior of the thermoplastic composite sheet product. For thermoplastic composites the mold temperature should cycle hot to cold, defined by the material being processed, pressure available and time to flow the material. For any given material the process is dependant on the proper combination of time, temperature and pressure.

Once the sheet has been molded, the temperature of the sheet can be reduced to a temperature below its glass transition temperature of the thermoplastic(s) making up the exterior and/or interior of the thermoplastic composite sheet product to allow for the facile release of the sheet from the surface of the mold. The rapid cooling of the molded sheet can be accomplished using those well known mold cooling techniques known to the skilled artisan. Such techniques commonly employ a mold which has an coolant intake means or valve, one or more channels which run behind the face surface of the mold, and a coolant outlet means or valve. A suitable medium is passed through the inlet means, through the channels and then out the outlet means. The inlet and outlet means can be, for example, openings, valves, regulators, etc. which are well known in the art.

The medium passed through the mold can be any medium which will reduce the temperature of the mold and/or the temperature of the molded sheet. The concerns which dictate which type of medium are well known and include: the speed with which the mold is to be cooled, the amount of temperature reduction necessary, the material from which the mold is made, the velocity of the media through the one or more channels, etc. In one embodiment of the present invention, water is employed as the medium having acceptable heat capacity, and heat transfer capability. Other media include gases such as, freon, or other chloro, flouro carbons, carbon dioxide, oxygen, nitrogen and helium. Liquids coolants including ethylene glycol, propylene glycol can also be used.

The temperature and speed which the medium is run through the mold is another way in which the mold and/or the molded sheet can be cooled rapidly to reduce cycle time. The use of a cold media under pressure or a cold media's fast velocity through the mold channels can rapidly cool the mold and can provide significant reductions in cycle time. For example, in one embodiment of the present invention, cold water is quickly cycled through the channels between heating cycles to reduce the temperature of the mold face surface from a temperature above the melt temperature of the thermoplastic resin(s) making up the sheet material to a temperature below the glass transition temperature of the thermoplastic resin(s) making up the sheet material.

The typical injection molding system according to the present invention contains a mold having a top half and a bottom half which are capable of being opened and closed during a molding cycle to create an article of manufacture. As is well known in the art, the mold is closed over the sheet material having one or more different thermoplastic matrices and then the mold will cool and the thermoplastic sheet will have molded into its desired shape. Subsequently, the mold will open and the article will be ejected from the inside of the mold by an ejection system, so that the next sheet can be molded.

The molded sheet having the intermediate or final form can be separated or ejected from the mold using any type of separation or ejection system known to the skilled artisan which will still meet the time constraints required of a commercial process for manufacturing molded thermoplastic composite sheets. The skilled artisan will appreciate that any of the numerous gas, mechanical, manual and frame ejection systems can be employed.

U.S. Pat. Nos. 4,179,254 and 4,438,065 show conventional methods for ejecting workpieces with closed front ends using stripper rings supplemented by venting holes, slots or air valves in the mold core to break the vacuum created between the core and the molded part or workpiece during ejection and to prevent collapsing of the workpiece. The skilled artisan will appreciate that increasing the air supply through the air vents or valves within the mold cavity can be employed to “blow” a workpiece or sheet off the mold.

In one embodiment of the present invention, a frame separation system is employed whereby the outer edge of the mold lifts away from central portion of the mold surface to lift the molded sheet product from the mold, freeing the mold to accept another unmolded thermoplastic sheet.

The product produced according to the present invention can be any thermoplastic composite sheet material. The sheet material can be single or multi-layer. The laminate structure can be: A, AB, ABA, ABC, ABABA, ABCBA, ACBCA, etc. whereby each capital letter represents a different layer of material. In one embodiment of the present invention the ABA structure is used where the A layers are high strength and the B layer is neutral to make a stress skin or truss construction

The thermoplastic resins making up the sheet may be any known in the art including, but not limited to: amorphous thermoplastic polymers including PPSU, PEI (poly(ether imide)), PSU, PC (Polycarbonate), PPO (polyphenylene ether), PMMA (polymethylmethacrylate), ABS, PS (polystyrene) and, PVC (polyvinylchloride), Crystalline thermoplastic resins including PFA, MFA, FEP, PPS (poly(phenylene sulfide), PEK (poly(ether ketone), PEEK (poly(ether-ether ketone), ECTFE, PVDF (polyvinylidenefluoride), PTFE (polytetrafluoroethylene), PET (polyethylene terephthalate), POM (polyacetal), PA (polyamide), UHMW-PE (ultra high molecular weight polyethylene), PP (polypropylene), PE (polyethylene), HDPE (high density polyethylene), LDPE (low density polyethylene) and advanced engineering resins such as PBI (polybenzimidizole) and PAI (poly(amide-imide), as well as blends, co-polymers thereof. PES (polyether sulfone), PAI (polyamide-imide), PAS (polyaryl sulfone) and combinations thereof.

The fibers employed in the composite thermoplastic sheet are selected such that a fiber-reinforced plastic is formed. Fiber type, size, amount, and the like may vary with the plastic material employed in making the substrate and the end use application. In one embodiment, the fibers are selected to impart the desired void volume to the substrate. In order to attain the desired mold replication and a desired void volume, the fibers can be capable of lofting (e.g., of expanding in the z-direction when heated). Exemplary fiber types include, but are limited to, glass fibers (e.g., E-glass (“electrical glass”, e.g., borosilicate glass), S-glass (“structural glass”, e.g., magnesia/alumina/silicate glass), and the like), carbon fibers, mineral fibers, polymer fibers, including but not limited to polyaramides and poly-paraphenylene terephthalamide (sold under the KEVLAR® trademark by the DuPont Company of Wilmington, Del.), metal fibers, natural fibers, and the like, as well as combinations of fibers comprising at least one of the foregoing fibers. Optionally, the fiber diameter (width) may be between about 1 and 100 micrometers or between about 6 micrometers to about 25 micrometers. Optionally, the fiber length may be about 1 to about 250 mm or from about 2 millimeters (mm) to about 75 mm. Fiber length may also be continuous so that continuously reinforced materials including but not limited to uni or bidirectional tape prepregs, commingled/woven systems, commingled knitted fabrics, etc.

The composite sheet comprises a sufficient amount of plastic material and fibers to provide the desired structural integrity and void volume to the substrate. For example, the fiber-reinforced plastic substrate can comprise about 10 weight percent (wt. %) to about 85 wt. % or specifically from about 25 wt. % to about 75 wt. % plastic material, or more specifically from about 35 wt. % to about 65 wt. %, and even more specifically about 40 wt. % to about 60 wt. % plastic material may be employed. About 25 wt. % to 75 wt. % fibers with the plastic material, specifically about 35 wt. % to about 65 wt. % and more specifically about 40 wt. % to about 60 wt. % fibers may be used. The weight percents are based on the total weight of the fiber-reinforced plastic substrate.

Other ingredients may also be employed in one or more layers of the thermoplastic composite sheets according to the present invention. Such ingredients include, for example, mineral fillers, such as mica, talc or clay, improves the modulus while lowering cost. Mineral fillers may also be selected from the group consisting of kaolin, calcium carbonate, TiO₂, fummed & ppt silica, plastic fiber & spheres, ppt calcium carbonate, rice hulls and nut shells. The particle size of the fillers also improves the capacity of the reinforcements to fill the deep rib portions of the I-beam. Fillers may also be used to reduce the permeability of the sheet material.

Specific examples of sheet material sold commercially which may be used in the instant process include “FRP” (for fiber reinforced panels) sold by Fiber-Tech Industries, Inc.; any of the “LWRT” (light weight reinforced thermoplastic) panels sold by Quadrant EPP USA, Inc. of Reading, Pa. under, for example, the SYMALITE® tradename: any of the THERMO-LITE® sheets manufactured by Phoenixx TPC, Inc. of Taunton, Mass.; and, AZDEL® SuperLite® and AZDEL® Glass Mat Thermoplastics (GMT), which are available from AZDEL, Inc., Shelby, N.C., having various matrices including, but not limited to, polyproplylene, polycarbonate (e.g., LEXAN® from General Electric Company), polyester (e.g., VALOX® from General Electric Company), polyetherimide (e.g., ULTEM® from General Electric Company), polyarylene ether (e.g., polyphenylene ether; PPO® Resin from General Electric Company), polystyrene, polyamide and/or combinations comprising at least one of the foregoing.

The surface of the sheet may also be laminated with one or more film or sheet products to impart an aesthetic or functional surface to the thermoplastic composite sheet product. These processes are known in the art.

The permeable decorative film layer is formed from materials that can withstand processing temperatures of between about 100° C. and about 425° C. The film material desirable may have a LOI greater than about 22, as measured in accordance with ISO 4589 test method which can be used for forming the thermoplastic films, for example, poly(ether imide), poly(ether ketone), poly(ether-ether ketone), poly(phenylene sulfide), poly(ether sulfone), poly(amide-imide), poly(aryl sulfone) and combinations thereof. In one embodiment of the present invention, the fibers used in forming the scrims have a LOI greater than about 20, as measured in accordance with ISO 4589 test method.

The composite thermoplastic sheet may have an open cellular fibrous layer which comprises a sufficient amount of plastic material and fibers to provide the desired structural integrity and void volume to the substrate. For example, the fiber-reinforced plastic substrate can comprise about 25 weight percent (wt. %) to about 75 wt. % plastic material, specifically about 35 wt. % to about 65 wt. %, and more specifically about 40 wt. % to about 60 wt. % plastic material may be employed. About 25 wt. % to 75 wt. % fibers with the plastic material, specifically about 35 wt. % to about 65 wt. % and more specifically about 40 wt. % to about 60 wt. % fibers may be used. The weight percents are based on the total weight of the fiber-reinforced plastic substrate.

For example, the open cellular fibrous substrate may be produced according to the Wiggins Teape method (e.g., as discussed in U.S. Pat. Nos. 3,938,782; 3,947,315; 4,166,090; 4,257,754; and 5,215,627). For example, to produce a mat according to the Wiggins Teape or similar method, fibers, thermoplastic material(s), and any additives are metered and dispersed into a mixing tank fitted with an impeller to form a mixture. The mixture is pumped to a head-box via a distribution manifold. The head box is located above a wire section of a machine of the type utilized for papermaking. The dispersed mixture passes through a moving wire screen using a vacuum, producing a uniform, fibrous wet web. The wet web is passed through a dryer to reduce moisture content and, if a thermoplastic is used, to melt the thermoplastic material(s). A non-woven scrim layer may also be attached to one side or to both sides of the web to facilitate ease of handling the substrate (e.g., to provide structural integrity to a substrate with a thermoset material). The substrate can then be passed through tension rolls and cut (guillotined) into the desired size.

Alternatively the sheet may be made according to a continuous method for producing a thermoformable semi-finished product from a thermoplastic such as a polyether imide and reinforcing fibers. The method comprises the following steps: A) blending a thermoplastic, such as PEI fibers, together with reinforcing fibers to give a dry-laid blended web; B) consolidating the blended web by needle bonding; C) heating the consolidated blended web; and D) compacting the semi-finished product. Thermoplastic, for example, polyetherimide (PEI) fibers and non-bound reinforcing fibers are continuously laid down by an air lay-up or carding method and needled. The fleece produced is heated, for example, in a contact or circulating oven or by infra-red radiation to above the softening temperature of PEI. Consolidation of the fleece into a glass mat reinforced thermoplastic sheet (GMT) is effected in either a calender, a polishing stack or a coating machine. Functional layers are simultaneously or subsequently pressed onto the semi-finished product. Sheet so produced may be a GMT sheet 0.2-4 mm thick comprising 10-80 wt % of PEI and 90-20 wt % of reinforcing fibers with a mean length of 40-200 mm homogeneously mixed together. This method is described in more detail in EP1373375 and its U.S. equivalents which are herein incorporated by reference in their entirety.

The composite thermoplastic sheet may be covered with an aesthetic or decorative film, sheet or layer, as for example, set forth in the application titled “MULTILAYER SHEET FOR HEADLINER”, filed Oct. 11, 2005, assigned to GE, GE docket Number 194618, in the name of Eric Teutch et al., herein incorporated by reference in its entirety as though set forth in full. This application describes a decorative film layer which is adhered to the open cellular fibrous layer through an open web comprising an adhesive. One web that may be utilized is a linear low-density polyethylene adhesive web. The open cellular fibrous layer is adhered to the insulating fiberglass layer with contact adhesive. The insulating fiberglass is typically composed of resin bonded glass fibers with a reinforced vapor retardant facing applied to the outside surface and a fiber glass textile mat bonded to the inner surface which is adhered to the open cellular fibrous layer. Typical contact adhesives, which are commercially available, comprise water dispersed, high solids, activated adhesive which provides immediate bonding capabilities. The resulting multilayer sheet has a desirable adhesion between each of the layers greater than 1 lb./inch. The multilayer sheet desirable meets the Surface Flammability and Specific Optical Density of Smoke requirements tested according to ASTM E162 and E662 in compliance with requirements of the Federal Rail Authority of the United States of America. The composite multilayer sheet desirable has an air flow resistance between 200 and 3000 MKS Rayls as measured by ASTM D-3574/95. The multilayer sheet desirable has an Average Absorption Coefficient (AAC) between 0.6 and 0.8. as measured by ASTM C423-99 when the panel is supported over a 4″ (100 mm) cavity filled with Aeroflex Insulation Fiberglass. A measurement is set forth in the attached graph called Hushliner FR.

The composite sheet may be thermoformed into a shape substantially corresponding to the shape of the desired final article. Generally, thermoforming comprises the sequential or simultaneous heating and forming of a material onto a mold, wherein the material is originally in the form of a sheet and is formed into a desired shape. Once the desired shape has been obtained, the formed article is cooled below its solidification or glass transition temperature. Generally, any thermoforming method capable of quickly producing a formed substrate to reduce the cycle time would be acceptable. For example, thermoforming methods include, but are not limited to, mechanical forming (e.g., matched tool forming), membrane assisted pressure/vacuum forming, membrane assisted pressure/vacuum forming with a plug assist, and the like.

The above described thermoforming methods are provided merely for exemplary purposes. It is to be understood that the substrate may be formed by any thermoforming method, wherein the resulting molded substrate has a void content such that a vacuum may be applied through the substrate.

After thermoforming the substrate to produce a shaped substrate, the shaped substrate may optionally be trimmed to substantially the final shape of the desired article. The trimming may occur prior to or subsequent to disposing of the film layer on the shaped substrate. The trimming method may include, for example, laser trimming, water jet trimming, trim press trimming, and the like, as well as combinations comprising at least one of the foregoing methods.

Structural articles formed using the materials and methods disclosed herein may include any use where a layered plastic article may be advantageous. For example, articles include but are not limited to, exterior and interior components for aircraft, automotive (e.g., cars, trucks, motorcycles, and the like). For example, various components include, but are not limited to panels, quarter panels, rocker panels, vertical panels, horizontal panels, fenders, head liners, doors, and the like.

Advantageously, the methods disclosed herein simplify the production of unpainted, cosmetic, structural parts and panels compared to methods employing thermosetting materials. In various embodiments, the production of these parts can proceed on a single forming station with greater efficiency than is currently possible. Methods that use thermoforming have required a separate, non-thermoforming step to dispose the substrate or sub-layer onto a shaped layer (e.g., a shaped film layer), e.g., by spraying, injecting, or the like. However, by employing a substrate with a sufficient void volume to enable a vacuum to be pulled through the shaped substrate to pull another layer onto that substrate, the film layer can also be applied using thermoforming. Since the shaped substrate can be formed on a male or female mold, the subsequent layer (e.g., film layer) can be an aesthetic layer applied to an outer surface of the shaped substrate.

This method reduces the types of equipment used to produce these layered products and can decrease formation time and simplify the layered article manufacturing process. In addition, when this thermoforming method does not employ a thermosetting material, VOC emissions are greatly reduced, if not eliminated, compared to other method using a thermosetting material. The relatively low pressures that are employed in the methods disclosed herein also allows for relatively low tooling costs. Finally, the porous nature of the underlying substrate structure helps reduce thermo-elastic stresses that arise during the attachment of the surface layer.

Without further elaboration, it is believed that the skilled artisan can, using the description herein, make and use the present invention. The following examples are included to provide additional guidance to those skilled in the art of practicing the claimed invention. These examples are provided as representative of the work and contribute to the teaching of the present invention. Accordingly, these examples are not intended to limit the scope of the present invention in any way. Unless otherwise specified below, all parts are by weight.

### EXAMPLE

Ten sheets of modified Azdel SUPERLITE® sheet are placed sequentially on a moving pin type conveyor belt which moves through an oven. The modified SUPERLITE® sheet is SUPERLITE® sheet having two layers of unidirectional glass tape comprising glass fibers in a matrix of XENOY polymer available from GE, situated on both the top and bottom surfaces of the sheet (ie two sheets on the top and two sheets on the bottom of the SUPERLITE® sheet. The two sheets of glass mat on both the top and bottom surfaces of the sheet are at a 0° and 90° orientation to each other, such that the long axis of glass fiber in the two sheets are approximately perpendicular to each other. The oven is an electrical resistance oven available from Dial Temp Oven, Blasdel Enterprise, Inc., 495 West Mckee Street, P.O. Box 260, Greensburg, Ind., 47240, serial number 5573. The oven is capable of attaining at least 500° F. The conveyor belt moves the sheet through the Blasdel oven at a speed sufficient such that when the thermoplastic composite sheet leaves the oven, the thermoplastic resin making up the sheet will be at or above their melt temperature(s), in this case having a surface temperature of approximately 500° F., and the sheet will have the consistency of woven shirt cloth. The sheet spends approximately three minutes total in the oven.

While the sheet is in the pre-heating oven the mold is preheated to a temperature of between 400° F. to 500° F. using induction heat. The induction heat is provided by a power generator and matching head, EFD Cami 300 RF generator available from EFD, Grenoble, France and an induction coil and manifold from RocTool, Chambry, France. This preheating of the mold step takes approximately three minutes and is done at the same time that a sheet is moving through the pre-heating oven.

The sheet exits the pre-heating oven and moves towards the mold. The conveyor belt then correctly positions (drop) the molten thermoplastic sheet material into the mold cavity. The mold is actuated by moving the upper and lower mold face surfaces together until they come into contact with the composite thermoplastic sheet and a pressure of 500 lbs/in². The mold face surfaces are again heated by induction using the apparatus described above to a temperature of approximately 450° F. to 500° F. for a period of thirty seconds. The time for the mold go from an open position to a closed position takes approximately 1 full minute.

The mold is opened, and water at a temperature of approximately 40° F., is run through the channels behind the mold face surface until the temperature of the mold is below 200° F. This process takes between 3 and 4 minutes.

When the molded sheet separates from the mold face, the untrimmed full sized automobile engine hood is ejected from the mold by a frame ejection system manually. The sheet is then inspected and an operator verifies that the mold is clean and free of debris. This process takes approximately 2 minutes.

This process is repeated ten (10) times until all sheets placed on the conveyor have been molded. The cycle time is then calculated to be 12 minutes.

All aforementioned patents, patent applications and other publications are herein specifically incorporated by reference in their entirety, as though set forth in full.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A process for reducing cycle time required to convert thermoplastic composite sheet to a final or intermediate product comprising:
i) heating the sheet to a temperature above the melting temperature of the thermoplastic resin in the sheet;
ii) applying a shape to the sheet material to form an intermediate for final product;
iii) wherein the conversion process has a cycle time of under 45 minutes.

2. A process for improving the cycle time that it takes to prepare a final or intermediate molded product from a thermoplastic composite sheet according to claim 1 wherein the molded thermoplastic composite material is removed from the mold by an ejection system.

3. A process for improving the cycle time that it takes to prepare a final or intermediate molded product from a thermoplastic composite sheet according to claim 1 wherein one entire cycle takes less than 30 minutes.

4. A process for improving the cycle time that it takes to prepare a final or intermediate molded product from a thermoplastic composite sheet according to claim 1 wherein one entire cycle takes less than 25 minutes.

5. A process for improving the cycle time that it takes to prepare a final or intermediate molded product from a thermoplastic composite sheet according to claim 1 wherein one entire cycle takes less than 20 minutes.

6. A process for improving the cycle time that it takes to prepare a final or intermediate molded product from a thermoplastic composite sheet according to claim 1 wherein one entire cycle takes less than 15 minutes.

7. A process for improving the cycle time that it takes to prepare a final or intermediate molded product from a thermoplastic composite sheet according to claim 1 wherein one entire cycle takes less than 14 minutes.

8. A process for improving the cycle time that it takes to prepare a final or intermediate molded product from a thermoplastic composite sheet according to claim 1 wherein one entire cycle takes less than 13 minutes.

9. A process for improving the cycle time that it takes to prepare a final or intermediate molded product from a thermoplastic composite sheet according to claim 1 wherein one entire cycle takes less than 12 minutes.

10. A process for improving the cycle time that it takes to prepare a final or intermediate molded product from a thermoplastic composite sheet according to claim 1 wherein one entire cycle takes less than 11 minutes.

11. A process for improving the cycle time that it takes to prepare a final or intermediate molded product from a thermoplastic composite sheet according to claim 1 wherein one entire cycle takes less than 10 minutes.

12. A process for improving the cycle time that it takes to prepare a final or intermediate molded product from a thermoplastic composite sheet according to claim 1 wherein one entire cycle takes less than 9 minutes.

13. A process for improving the cycle time that it takes to prepare a final or intermediate molded product from a thermoplastic composite sheet according to claim 1 wherein one entire cycle takes less than 8 minutes.

14. A process for improving the cycle time that it takes to prepare a final or intermediate molded product from a thermoplastic composite sheet according to claim 1 wherein one entire cycle takes less than 7 minutes.

15. A process for improving the cycle time that it takes to prepare a final or intermediate molded product from a thermoplastic composite sheet according to claim 1 wherein one entire cycle takes less than 6 minutes.

16. A process for improving the cycle time that it takes to prepare a final or intermediate molded product from a thermoplastic composite sheet according to claim 1 wherein one entire cycle takes less than 5 minutes.

17. A process for improving the cycle time that it takes to prepare a final or intermediate molded product from a thermoplastic composite sheet according to claim 1 wherein one entire cycle takes less than 4 minutes.

18. A process for improving the cycle time that it takes to prepare a final or intermediate molded product from a thermoplastic composite sheet according to claim 1 wherein one entire cycle takes less than 3 minutes.

19. A process for improving the cycle time that it takes to prepare a final or intermediate molded product from a thermoplastic composite sheet according to claim 1 wherein one entire cycle takes less than 2 minutes.

20. A process for improving the cycle time that it takes to prepare a final or intermediate molded product from a thermoplastic composite sheet according to claim 1 wherein one entire cycle takes less than 1 minute.

21. A process for improving the cycle time that it takes to prepare a final or intermediate molded product from a thermoplastic composite sheet according to claim 1 wherein one entire cycle takes between 2 minutes and 5 minutes.

22. A process for improving the cycle time that it takes to prepare a final or intermediate molded product from a thermoplastic composite sheet according to claim 1 wherein one entire cycle takes between 5 minutes and 10 minutes.

23. A process for improving the cycle time that it takes to prepare a final or intermediate molded product from a thermoplastic composite sheet according to claim 1 wherein one entire cycle takes between 10 minutes and 15 minutes.

24. A process for improving the cycle time that it takes to prepare a final or intermediate molded product from a thermoplastic composite sheet according to claim 1 wherein one entire cycle takes between 15 minutes and 30 minutes.

25. A process for improving the cycle time that it takes to prepare a final or intermediate molded product from a thermoplastic composite sheet according to claim 1 wherein one entire cycle takes between 30 minutes and 45 minutes.

26. A process for improving the cycle time that it takes to prepare a final or intermediate molded product from a thermoplastic composite sheet according to claim 1 wherein the thermoplastic composite sheet has multiple layers and wherein two or more of the layers are the same composition.

27. A process for improving the cycle time that it takes to prepare a final or intermediate molded product from a thermoplastic composite sheet according to claim 1 wherein the thermoplastic composite sheet has multiple layers in an A B A orientation.

28. A process for improving the cycle time that it takes to prepare a final or intermediate molded product from a thermoplastic composite sheet according to claim 1 wherein the thermoplastic composite sheet has multiple layers in an A B A B A orientation.

29. A process for improving the cycle time that it takes to prepare a final or intermediate molded product from a thermoplastic composite sheet according to claim 1 wherein the thermoplastic composite sheet contains more than 50% of a mineral filler material.

30. A process for improving the cycle time that it takes to prepare a final or intermediate molded product from a thermoplastic composite sheet according to claim 1 wherein the thermoplastic composite sheet contains more than 50% of reinforcing fibers.

31. A process for improving the cycle time that it takes to prepare a final or intermediate molded product from a thermoplastic composite sheet according to claim 1 wherein the thermoplastic composite sheet is highly filled with reinforcing fibers selected from the group consisting of glass, carbon, aramide and ceramic.

32. A process for improving the cycle time that it takes to prepare a final or intermediate molded product from a thermoplastic composite sheet according to claim 1 wherein the thermoplastic composite sheet is highly filled with a mineral filler.

33. A process for improving the cycle time that it takes to prepare a final or intermediate molded product from a thermoplastic composite sheet according to claim 1 wherein the ejection system is selected from the group consisting of mechanical, air and frame ejection system.

34. A process for improving the cycle time that it takes to prepare a final or intermediate molded product from a thermoplastic composite sheet according to claim 1 wherein the mold is heated using an induction heating process.

35. A process for improving the cycle time that it takes to prepare a final or intermediate product from a thermoplastic composite sheet comprising:
i) heating the sheet to a temperature above the melting temperature of the thermoplastic resin making up the sheet;
ii) applying a shape to the sheet material;
iii) removing the molded sheet from the mold; and,
wherein the process has a cycle time to produce a molded sheet is under 45 minutes.

36. An intermediate or final molded product comprising a thermoplastic sheet material whose final shape was provided in a cycle time of less than 30 minutes.

37. A process for improving the cycle time that it takes to prepare a final or intermediate product from a thermoplastic composite sheet comprising:
a) conveying a thermoplastic composite sheet material to a mold;
b) situating the thermoplastic composite sheet material in a heated mold;
c) actuating the mold so that the thermoplastic sheet material takes on the shape of the mold cavity;
d) cooling the surface of the mold cavity which comes into contact with the thermoplastic composite sheet for a period of time sufficient to allow the thermoplastic composite sheet to release from the mold;
e) ejecting the thermoplastic composite sheet material in its final shape from the mold and wherein the cycle time to produce a molded sheet product is less than 45 minutes.

38. A process for improving the cycle time that it takes to prepare a final or intermediate product from a thermoplastic composite sheet according to claim 38 comprising the additional step of pre-heating the thermoplastic composite sheet material to a temperature above the melting point of the thermoplastic resin making up the outermost layers of the sheet material.

39. A process for improving the cycle time that it takes to prepare a final or intermediate product from a thermoplastic composite sheet according to claim 38 comprising the additional step of adding one or more decorative permeable films to at least one surface of the sheet.

40. A multilayer sheet comprises an outer layer of a decorative permeable film, an adherent layer of insulating fiberglass, and an open cellular fibrous layer intermediate the outer decorative film layer and the insulating fiberglass, said open cellular fibrous layer comprises fibers bonded together with a thermoplastic resin and said outer decorative layer is adhered to the open cellular fibrous layer through a permeable adhesive web.

41. A multilayer sheet according to claim 1 wherein the multilayer sheet has the inherent properties desired for the performance required for locomotive headliners.

42. A multilayer sheet according to claim 1 wherein the multilayer sheet has a desirable adhesion between each of the layers greater than 1 lb./inch.

43. A multilayer sheet according to claim 1 wherein the multilayer sheet desirable meets the Surface Flammability and Specific Optical Density of Smoke requirements tested according to ASTM E162 and E662 in compliance with requirements of the Federal Rail Authority of the United States of America.

44. A multilayer sheet according to claim 1 having an air flow resistance between 200 and 3000 MKS Rayls as measured by ASTM D-3574/95.

45. A multilayer sheet according to claim 1 having an Average Absorption Coefficient (AAC) between 0.6 and 0.8. as measured by ASTM C423-99 when the multilayer sheet is supported over a 4″ (100 mm) cavity filled with Aeroflex Insulation Fiberglass.

46. A multilayer sheet according to claim 1 wherein the multilayer sheet meets acoustical requirements.

47. A multilayer sheet according to claim 1 wherein the multilayer sheet is formed into a substrate of the desired shape by heating.
